(19) United States
(12) Patent Application Publication
(10) Pub. No.: US 2010/0236423 A1
(43) Pub. Date: Sep. 23, 2010

(54) AUTOMATED MACHINE FOR FRIED DOUGH FOODS FRIED IN PANS

(76) Inventors: Istvan Janosi, Budapest (HU); Peter Roman, Budapest (HU); Laszlo Vogronics, Erd (HU)

Correspondence Address: Hershkovitz & Associates, LLC, 2845 Duke Street, Alexandria, VA, 22314, US

(21) Appl. No.: 12/522,168

(22) PCT Filed: Dec. 28, 2007
(86) PCT No.: PCT/HU07/00130

§ 371 Date: May 5, 2010

(30) Foreign Application Priority Data
Jan. 5, 2007 (HU) P0700005

(51) Int. Cl. A47J 37/12

(52) U.S. Cl. 99/407

(57) ABSTRACT

The invention relates to a machine for fried dough foods fried in pans, wherein the machine comprises a preferably thermally insulated housing, which has a pan that is provided above the heating device disposed in the lower part of the machine. The invention further relates to a dough dispenser for the machine for fried dough food types fried in pans, wherein a feed worm having a diameter that corresponds to the diameter of the feed opening is disposed in the closable feed opening of the uncooked dough container of the dough dispenser.

The subject-matter of the invention is an automatic unit for making deep-fried pastries, which possesses a heating element arranged on the bottom of the automatic device and a frying pan above it, and which preferably has a heat-insulated casing. The subject-matter of the invention furthermore is a dough feeder for the automatic unit suitable for making deep-fried pastries, which possesses a soft dough receiver whose closable opening possesses a feeder sheave corresponding in size to the feeder opening.

Special machines have been in use for a long time to make deep-fried pastries, especially doughnuts, which are popular worldwide. Such machines are usually equipped with conveyor belts immersed in fat. The uncooked dough is placed on one end, the half done doughnuts are flipped over halfway on the conveyor belt then the finished doughnuts are removed at the other end. Standard description No. EP 0 212 658 A2 describes such a machine, for example.

In another solution, which is described in the publication document associated with patent application No. HU P9101449, the frying process is accelerated by way of the conveyor being fully submerged, so the doughnut is fried at once without needing to flip it over. This solution, however, fails to provide doughnuts of appropriate quality because the conveyor belt prevents one side from frying properly.

The advantage of such units is that they are able to fulfill the demand where large quantities of doughnuts must be produced. They have a disadvantage, however, in that they require a great amount of space since the raw dough travels from one end of the frying pan to the other, in other words a remarkably large hot oil pan is required, therefore, they are uneconomical and usually non-enclosed equipment so they pollute the environment considerably.

OTEX Kft. (Debrecen) made a doughnut frying unit for preparing small quantities of doughnuts. In this unit the doughnuts are fried in four stages. In the first stage a feeding mechanism dispenses the raw soft dough. In the second stage the dough is put into the hot oil in which one half of it is fried while floating therein. In the third stage the half done doughnuts are flipped over and the other half is fried in the end of the frying pan. In the fourth stage the machine removes the cooked doughnuts, drains off the surplus oil and they are removed from the fryer. So in each stage the doughnut remains in place but once a stage completes, it proceeds forward in a straight line. The quantity to be produced at any one time can be increased by adding several of such process lines, i.e., by increasing the width of the unit.

An advantage of this unit is that it requires a significantly smaller frying pan and accordingly less fat than equipment that employ conveyor belts. Its advantage is that, whenever pastries with a larger diameter than a doughnut are to be fried, the length of the line incorporating the four stages will grow in proportion to the diameter, and placement of the machine—on account of its size—will be problematic even if small quantities are involved.

It is probably due to the issue of size that langosh is usually fried manually—using conventional methods—even today, without the intervention of any machinery. At the same time, this Hungarian specialty is popular even with visiting tourists, and—most probably—with appropriate automation it could be distributed abroad just like pizza.

The purpose of the invention is to design an automated unit suitable for deep-frying pastries, particularly the large sized kind such as langosh, for example, which is able to prepare fried pastries in a quantity that meets the demand of small catering establishments, whose thermally sealed design renders it dust free, energy efficient and environmentally friendly, and whose compact design allows it to take up little space.

The basis of the invention is realization of the fact that if the raw dough is fed and the fried dough is removed at the lateral wall of the automatic unit's casing by horizontally rotating the dough placed on the frying plate in and out, and forming an enclosed frying unit by attaching a perforated frying plate cover to the frying plate inside the casing, which allows the dough to float in the oil when immersed, and when turning is done around the horizontal midline of the frying unit with the dough in place, then the casing can be made completely enclosed and environmentally friendly, and the size of the automatic unit can be minimized in accordance with the size of the dough pieces to be fried. We have furthermore recognized that raw dough dispensing, which can be done alongside the automatic unit's casing, can also be automated, moreover, by fashioning the bottom half of the locking plate below the feeder opening and/or the frying plate's surface into a particular shape, by making the parts facing each other convex in the case of langosh for example, the dough can be arbitrarily shaped prior to and after frying.

The automatic unit described in the invention has the following advantages:
There is an at least 180-degree opening on the lateral wall of the casing, near the casing, allowing the frying plate to be rotated out horizontally on a vertical axis formed by the guiding column on the feeder side inside the casing,
There is a frying plate cover arranged in the casing that can be guided vertically and temporarily fastened onto the frying plate,
The frying unit, consisting of a frying plate and frying plate cover fastened to each other, which can be rotated around its horizontal axis and fastened in its rotated position is designed so that it can be vertically lowered into and lifted out of the frying pan.

The dough feeder described in the invention features the following:
There is a (are) forming plate(s) below the feeder opening and
The feeder opening is closed off by a locking plate fashioned into an upper forming plate whose
Top, preferably flat, surface has a diameter exceeding that of the dough to be prepared, while
Its lower surface is shaped to allow forming of the soft dough by pressure, furthermore
There is a slider which frees the feeding opening by being retracted radially from the locking plate and
Which closes the feeder opening by being pushed back in.

The invention is demonstrated in greater detail through figures where:

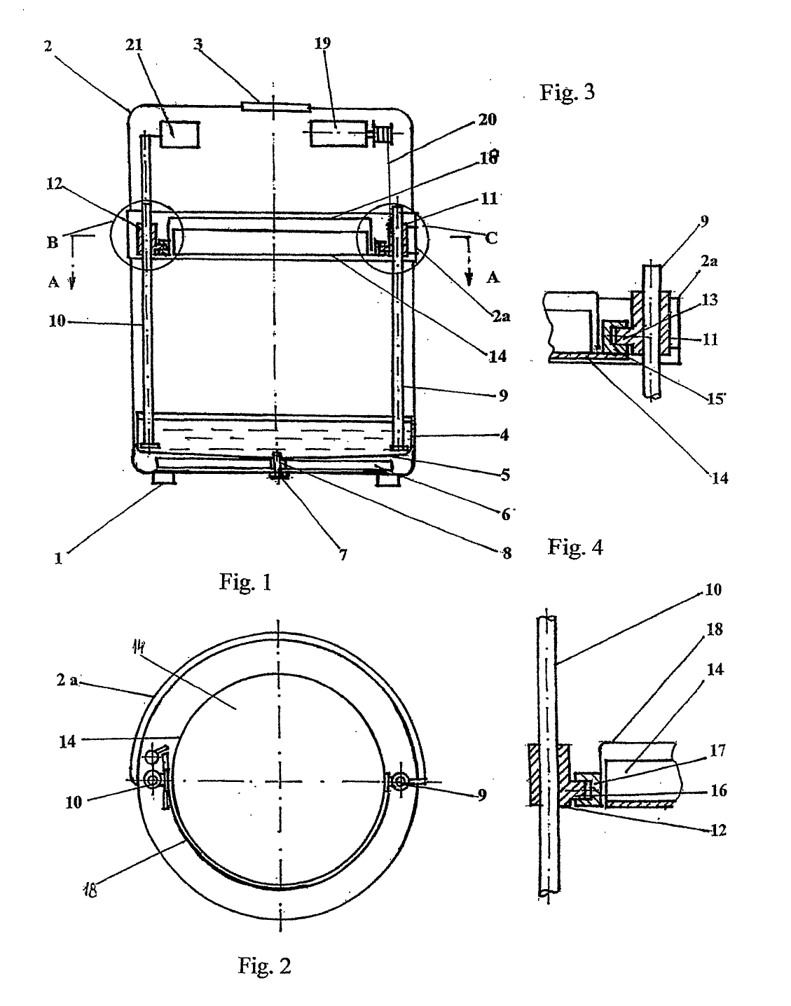

FIG. 1 shows a vertical section of an implementation of the automatic unit subject to the invention without a dough feeder,

FIG. 2 shows an A-A section of the automatic unit shown in FIG. 1,

FIG. 3 shows a magnified B detail of the automatic unit shown in FIG. 1,

FIG. 4 shows a magnified C detail of the automatic unit shown in FIG. 1,

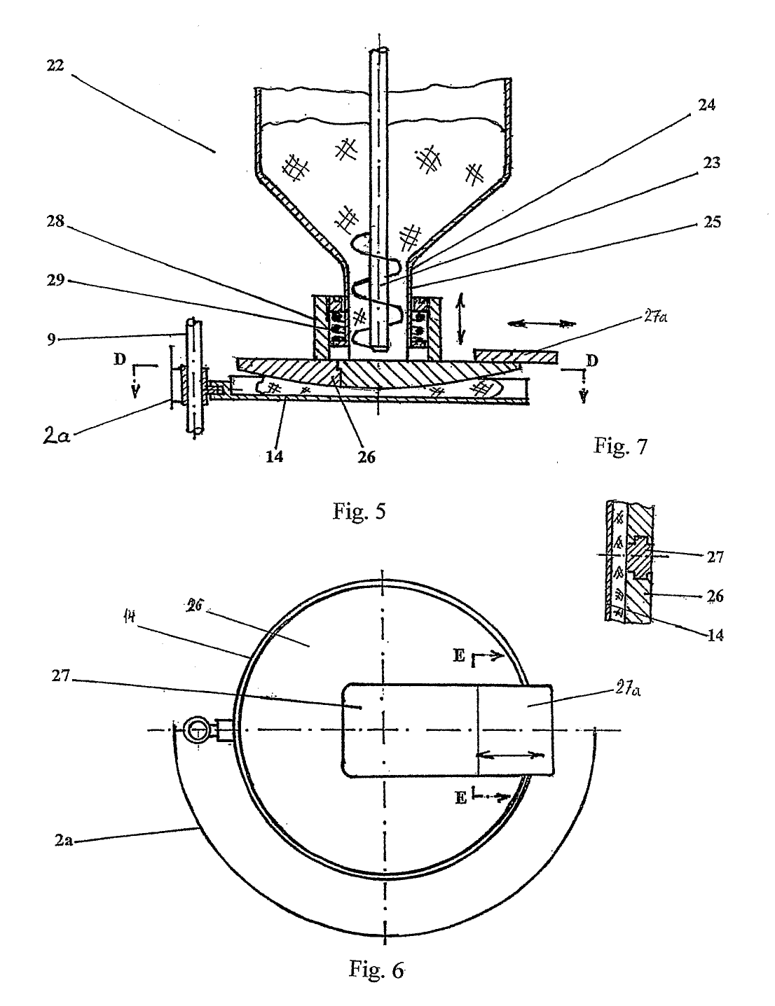

FIG. 5 shows an axial section of an implementation of the automatic unit subject to the invention,

FIG. 6 shows a D-D section of the automatic unit shown in FIG. 5 complemented by a casing section comprising a single unit with the frying plate, while

FIG. 7 shows an E-E section of FIG. 6.

Standing on legs 1, the heat-insulated and preferably cylindrical casing 2 of the automatic unit shown in FIG. 1 possesses a removable filter cartridge 3 on top of the casing 2. There is a frying pan 4 in the bottom part of the casing 2. There is an electric heating element 6 arranged between the bottom plate 5 of the frying pan 4 and the bottom of the oil reservoir of the casing 2.

For the benefit of cleaning, the bottom plate 5 is fashioned into a cone envelope that descends toward the axis of the casing 2. The bottom plate 5 of the frying pan 4 possesses an oil drain opening 8, preferably in line with the axis of the casing 2, that can be fastened by screws 7.

Guiding columns 9, 10 which run parallel to the axis of the casing 2, are arranged 180 degrees with respect to each other and on which there are sliding bushes 11, 12 arranged, extend into the frying pan 4 near the lateral walls of the casing 2 and inside the casing 2. There is a pin 13 on the bush 11 of the guiding column 9 extending at a right angle from it, and this pin 13 is designed so it can be rotated around bush 15 fastened to the frying plate 14. This is shown magnified in detail C in FIG. 3. There is an at least 180-degree opening on the lateral wall of the casing 2 allowing the frying plate 14 to be rotated out horizontally on a vertical axis formed by the guiding column 9. There is a casing section 2a attached to the frying plate 14 suitable for covering the opening on the casing 2.

On the opposite side, shown magnified in Detail B in FIG. 4, there is a pin 16 on the bush 12 of the other guiding column 10 extending at a right angle from the guiding column 10, and this pin 16 points toward the center of the frying plate 14, and because its axis coincides with pin 13, it is designed so it can be rotated around bush 17. The bush 17 is fastened to the lateral wall of the frying plate cover 18, which extends down to the frying plate 14 and which allows it to be fastened to the frying plate 14. The lateral wall of the frying plate cover 18, however, is only a 180-degree split skirt, thus it does not hinder the frying plate 14 when it is rotated outward. This is shown in FIG. 2. The frying plate cover 18, or at least the frying plate cover's 18 panel running parallel with the frying plate 14, is designed to be perforated or grill-like. The lowering of the frying plate cover 18 and its bearing against the rim of the frying plate's 14 lateral wall, as well as the lowering of the frying unit formed by its temporary joining with the frying pan 4 and its removal from there, is done by an electric motor 19 via a transmission chain 20. The rotation of the frying unit formed by the frying plate 14 and frying plate cover 18 around the pins 13, 16 by 2×180 degrees, or 2×90 degrees respectively for draining off surplus oil, as well as their fixing in a rotated position can be done using a conventional mechanism, such as a gear mechanism operated by a solenoid 21 in the example, or by a friction drive, coupling, etc.

Alongside the automatic deep-frying unit subject to the invention, there is a dough feeder 22 that can be integrated with the automatic unit. This is shown in FIG. 5. When rotated outward around the guiding column 9 by 180 degrees, the axis of the frying plate 14, along with the casing section 2a of the lateral wall of the casing 2 above the frying plate 14 which extends no further than the frying plate cover 18, will enter the axis of the dough feeder 22.

Considering that outward rotation takes place around the guiding column 9 situated inside the lateral wall, the arc of the casing section 2a will be greater than 180 degrees depending on the distance between the guiding column 9 and the lateral wall of the casing.

The dough feeder 22 consists of the following parts:

The dough feeder 22 possesses a feeder sheave 23 and a feeder opening 24 at the lower end of the feeder sheave 23. The soft dough feeder's 22 soft dough receiver 25 is conical and its feeder opening 24 ends in a cylinder corresponding in size to the a feeder sheave's 23 inner diameter. The feeder opening 24 is sealed by a locking plate 26 whose upper, preferably flat, surface is of a diameter exceeding that of the dough to be prepared, while its lower surface is shaped to allow forming the soft dough by pressure. In the case of preparing langosh, where the dough is thin on the inside and thicker toward the edge, the lower surface of the locking plate 26 is convex as shown in FIG. 1. Of course, the shape of the upper dough surface can be varied by changing the shape of the lower surface of the locking plate 26. The shape of the lower side of the dough can be varied with the aid of a lower forming plate which is integral with the automatic deep-frying unit, according to the shape of the frying plate 14 which can also be convex, for example.

The locking plate 26 can be moved vertically by a conventional actuator which is not pictured. There is a slider 27 arranged in the locking plate 26 opposite the guiding column 9, which can be pushed in and pulled out radially from the locking plate 26. This is illustrated in FIG. 6 and FIG. 7. The slider 27 can be moved via a tab 27a by a conventional actuator which is not pictured. Resetting the locking plate 26 is done by a spring 29 inside a spring housing 28 attached to the top of the locking plate 26.

The automatic deep-flyer unit, equipped with a dough feeder, subject to the invention operates as follows:

During the intervals between each feed, the locking plate 26 abuts on the springs 29 and the slider 27 is in a retracted state closing off the feeder opening 24. On the commencement of feeding, the slider 27 moves outward until the feeder opening 24 is completely open. The feeder sheave 23 dispenses a pre-measured quantity of soft dough onto the frying plate 14 via the feeder opening 24 and the open portion of the locking plate 26. The dispensed quantity can be set using any known method, so it is not subject to this invention. Once feeding is finished, the slider 27 retracts and the locking plate 26 closes. Afterwards, the mechanism that actuates the locking plate moves the locking plate 26 downward, against the force of the springs, compressing the soft dough dispensed onto the frying plate 14 into the desired shape and size. When this completes, the springs 29 reset the locking plate 26 into its upper position and the soft dough will be on the frying plate 14 ready to be fried.

Being rotated 180 degrees around the guiding column 9, the frying plate 14 enters the automatic deep-frying unit whose casing 2 thus closes then the frying plate cover 18 joins the frying plate 14. They will remain in such an enclosed state forming a frying unit until frying completes and/or until the fried dough is rotated back into the feeder along with the frying plate 14. Guided by the guiding columns 9, 10, the frying unit proceeds downward and is lowered into the oil heated to 180-190° C. by the heating element 6. While being fried, the dough floats in the oil, so only its bottom half is submerged in the frying oil and it is consequently fried. After an appropriately set frying time, the frying unit is raised by the electric motor 19 then the mechanism controlled by the solenoid 21 flips the frying unit 180 degrees around its diameter and the electric motor 19 lowers it in the frying oil again. Thus the other half of the dough will be fried. Once the frying time is up, the electric motor 19 raises the frying unit. The mechanism controlled by the solenoid 21 turns it over by 90 degrees, preferably in the same direction as before. The surplus oil will drip off the fried dough and once this completes the frying unit reaches a horizontal position again having rotated another 90 degrees. The frying plate 14 and the frying plate cover 18 come apart and the frying plate 14 is returned to the feeder by turning 180 degrees horizontally around the guiding column 9, thus facilitating removal of the finished fried dough from under the dough feeder 22.

1. An automatic unit for deep-fried pastries, which possesses a heating element arranged on the bottom of the automatic unit and a frying pan above with a preferably heat-insulated casing, characterized in that
There is an at least 180-degree opening on the lateral wall of the casing (2), near the casing (2), allowing the frying plate (14) to be rotated out horizontally on a vertical axis formed by the guiding column (9) on the feeder side inside the casing,
There is a frying plate cover (18) arranged in the casing (2) that can be guided vertically and temporarily fastened onto the frying plate (14),
A unit, consisting of a frying plate (14) and frying plate cover (18) fastened to each other, that can be rotated around its horizontal axis and can be fastened in its rotated position, is designed so that it can be vertically lowered into and raised from the frying pan (4).

2. The automatic unit described in claim 1 characterized in that the frying plate cover (18), or at least the frying plate cover's (18) panel running parallel with the frying plate (14), is designed to be perforated or grill-like.

3. The automatic unit described in claim 1 or 2 characterized in that there is a casing section (2a) suitable for covering the opening on the casing (2) attached to the frying plate (14).

4. The automatic unit described in any of claims 1 through 3 characterized in that there is another guiding column (10), parallel with the first guiding column (9), but shifted by 180 degrees relative to the guiding column on the feeder side (9), on the later wall of casing (2) inside and near the casing (2).
There are sliding bushes (11, 15) on the guiding columns (9, 10) and—there are pins (13, 16) on the bushes (11, 15) whose axes coincide with those of the bushes (11, 15) while
The pin (13) on the bush (11) of the guiding column on the feeder side (9) is in a bush (15) fastened to the frying plate (14) and
The pin (13) on the bush (10) of the other guiding column (10) is in a bush (17) fastened to the lateral wall of the frying plate cover (18) so as to facilitate rotation and allowing its fixation in a rotated position.

5. A dough feeder for the automatic unit suitable for making deep-fried pastries, which possesses a soft dough receiver whose closable opening possesses a feeder sheave corresponding in size to the feeder opening,
characterized in that
There is a (are) forming plate(s) below the feeder opening,
The feeder opening (24) is closed off by a locking plate (26) fashioned into an upper forming plate whose
Forming plate's (26) top, preferably flat, surface has a diameter exceeding that of the dough to be prepared, while
Its lower surface is shaped to allow forming of the soft dough by pressure, furthermore
In the locking plate (26) there is a slider (27) which frees the feeder opening (24) when pulled out radially from the locking plate (26) and
Which slider (27) closes the feeder opening (24) when retracted.

6. The dough feeder described in claim 5 characterized in that
The locking plate (26) can be moved vertically by a conventional actuator which is not pictured and
It is designed to allow resetting by a spring (29) inside a spring housing (28) attached to the top of the locking plate.

7. The dough feeder unit described in claim 5 or 6 characterized in that the lower surface of the locking plate (26) is convex making it suitable for frying langosh.

8. The dough feeder described in any of claims 5 through 7 characterized in that
The dough feeder (22) is integral with the automatic unit for making deep-fried pastries and
There is a frying plate (14) fashioned into a lower forming plate which can be rotated horizontally out of the automatic unit's casing 180 degrees around the vertical axis formed by the guiding column (9) on the feeder side while
The slider (27) of the locking plate (26) is arranged opposite the guiding column (9) on the feeder side.
